(19) United States
(12) Patent Application Publication
(10) Pub. No.: US 2012/0329293 A1
(43) Pub. Date: Dec. 27, 2012

(54) MAGNETIC CONNECTION CABLE

(75) Inventor: Hsiao-Han WANG, New Taipei City (TW)

(73) Assignee: K. S. TERMINALS INC., Xianxi Township (TW)

(21) Appl. No.: 13/352,660

(22) Filed: Jan. 18, 2012

(30) Foreign Application Priority Data
Jun. 23, 2011 (TW) 100211432

(51) Int. Cl. H01R 11/30

(52) U.S. Cl. 439/40

(57) ABSTRACT

A magnetic connection cable is composed of a main body and two magnets mounted to the main body. The main body includes a first end portion and a second end portion opposite to the first end. The two magnets are mounted to the first and second end potions separately. The first and second end portions of the magnetic connection cable can magnetically attract each other for convenient storage and effective reduction of the size of the connection cable in storage to overcome the drawback of the prior art. Besides, the connection cable of the present invention with the magnetic attraction can function as a general magnetic fastener for fastening an object, like paper, to the surface of a magnetically attractable object.

### BACKGROUND OF THE INVENTION

1. Field of the Invention

The present invention relates generally to a connection cable, and more particularly, to a magnetic connection cable.

2. Description of the Related Art

One end of the popular connection cable is mostly a universal serial bus (USB) port and the other end is an identical or different port, e.g. USB port or micro USB port, for data transmission between the computer and an electronic device, such as mobile phone, camera, PDA, or MP3 player.

Since the part between the two ends of the conventional connection cable is flexible, a user usually furls it for storage. However, such storage is not convenient and when the user intends to use the connection cable again after it is furled for longtime storage, the flexible connection cable easily keeps curly and it is difficult to recover its original shape. Besides, the connection cable is subject to damage resulting from excessive curvature due to longtime furl for storage.

### SUMMARY OF THE INVENTION

The primary objective of the present invention is to provide a magnetic connection cable, two ends of which can be magnetically connected with each other and which is convenient for storage.

The secondary objective of the present invention is to provide a magnetic connection cable, which can be used to fasten a nonmagnetic object to the surface of a magnetically attractable object.

The foregoing objectives of the present invention are attained by the magnetic connection cable composed of a main body and two magnets mounted to the main body. The main body includes a first end portion and a second end portion opposite to the first end. The two magnets are mounted to the first and second end potion separately and each of the magnets is not located on the center of an imaginary long axle of the main body. In this way, the first and second end portions of the magnetic connection cable can magnetically attract each other for convenient storage and for effective reduction of the size of the connection cable in storage to overcome the drawback of the prior art. Besides, the connection cable of the present invention with the magnetic attraction can function as a general magnetic fastener.

In the connection cable of the present invention, the main body includes a conducting wire and two casings sleeved onto a first distal end and a second distal end of the conducting wire. Each of the first and second distal ends and one of the two casings jointly define the first or second end portion. In the meantime, the two magnets can be mounted to the two casings. In consideration of durability and aesthetic appearance, the two magnets can be preferably mounted to respective inner sides of the casings.

In the connection cable of the present invention, at least one of the first and second end portions is preferably provided with a USB port.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is a perspective view of the preferred embodiment of the present invention, illustrating that the first and second end portions are magnetically connected with each other.

FIG. 4 is a schematic view of the preferred embodiment of the present invention, illustrating that the connection cable magnetically fastens a paper to a refrigerator.

### DETAILED DESCRIPTION OF PREFERRED EMBODIMENTS

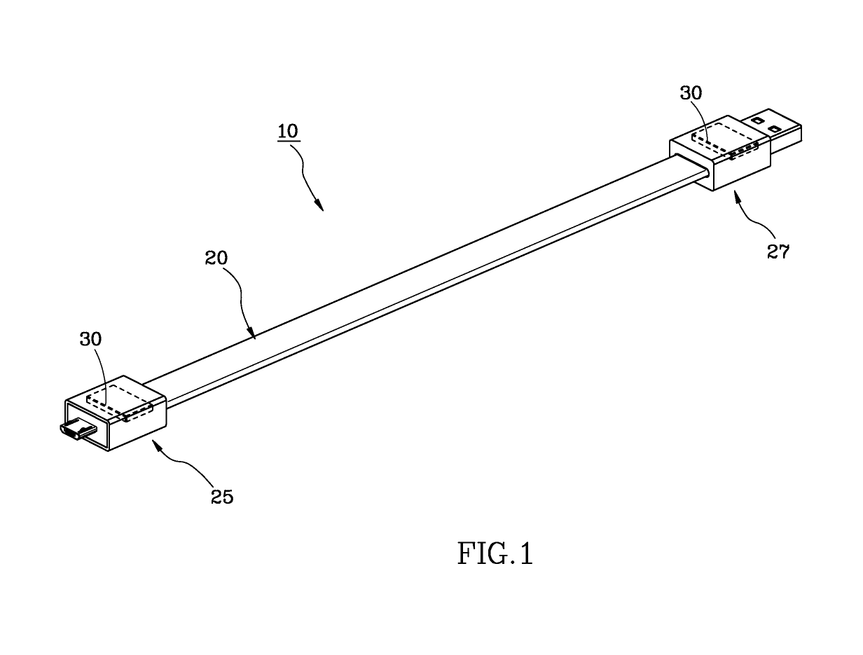

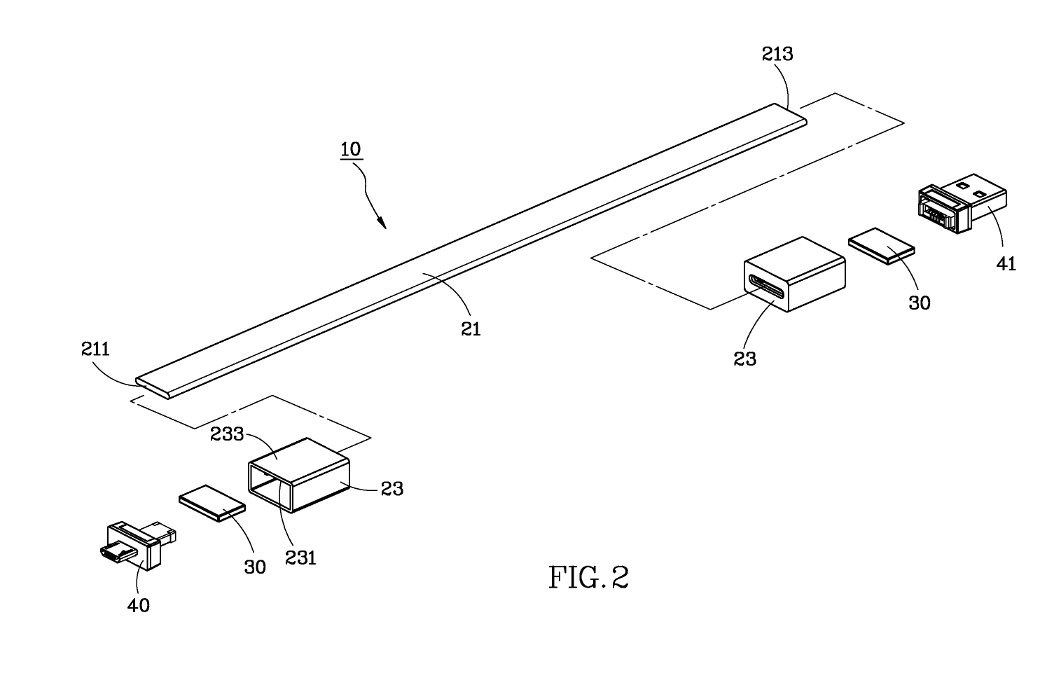

Referring to FIGS. 1-2, a magnetic connection cable 10 constructed according to a preferred embodiment of the present invention is composed of a main body 20 and two magnets 30. The detailed descriptions and operations of these elements as well as their interrelations are recited in the respective paragraphs as follows.

The main body 20 includes a conducting wire 21 and two casings 23. The two casings 23 are mounted to a first distal end 211 and a second distal end 214 of the conducting wire 21 separately to define a first end portion 25 and a second end portion 27 of the main body 20. The conducting wire 21 is flexible and in this embodiment, the first distal end 211 is electrically connected with a micro USB connector 40 and the second distal end 213 is electrically connected with a USB connector 41. In actual production, the first and second distal ends 211 and 214 can be electrically connected with other applicable connector, like mini USB connector, 1394 connector, micro HDMI connector, or standard HDMI connector.

In this embodiment, each of the magnets 30 is mounted to an inner side 231 of one of the casings 23 and not located at an imaginary long axis of the main body 20. If the durability and aesthetic appearance are not considered, each of the magnets 30 can be mounted to an outer side 233 of one of the casings 23. In other words, each of the magnets 30 is mounted to one of the casings 23, not located at the imaginary long axis of the main body 20, or to any other position of the casing 23 that the two casings 23 can be magnetically attracted to each other while they are close to each other. It is to be noted that if the magnets 30 are mounted onto the imaginary long axis of the main body 20, the production will become uneasy and the two casings 23 may not be successfully magnetically connected with each other subject to the influence of the connectors 40 and 41 mounted to the first and second distal ends 211 and 213 while the casings 23 are close to each other.

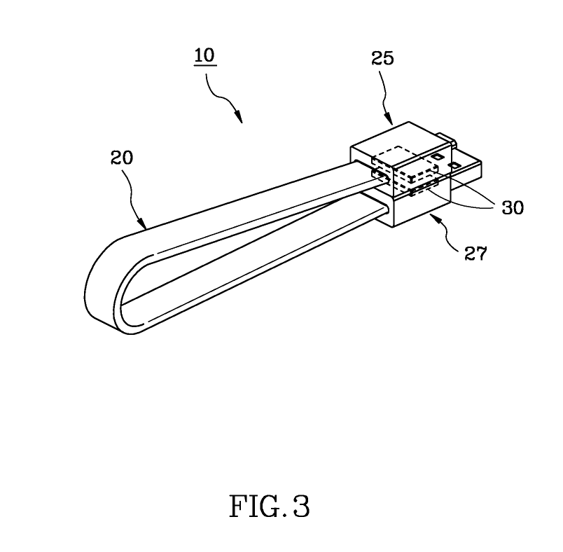

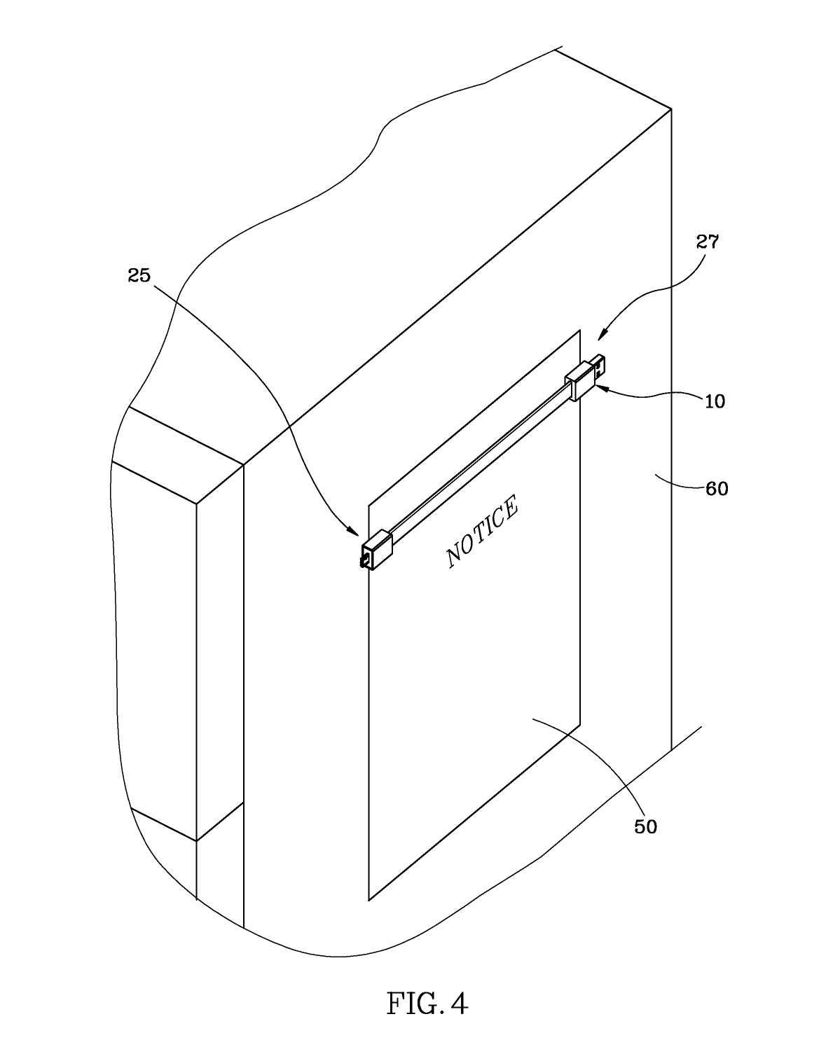

Referring to FIG. 3, in storage, each of the magnets 30 is mounted to the inner side 231 of one of the casings 23, so the first and second end portions 25 and 27 can magnetically attract each other via the magnetism of the magnets 30 for convenient storage and effective reduction of the size of the storage. Because the locations of the magnets 30 are deviated from the imaginary long axis of the main body 20, i.e. the magnets 30 are not located at where the connectors 40 and 41 extend outside, when the two casings 23 are close to each other, they can be firmly magnetically connected together. Referring to FIG. 4, when the present invention is actually applied as indicated above, where the two magnets 30 are mounted enables the connection cable 10 to function as a general magnetic fastener. In other words, the first and second end portions 25 and 27 are magnetically attractive due to the magnets 40, so the paper 50 can be firmly fastened to the surface of a magnetically attractable member like refrigerator 60.

In conclusion, the magnet is mounted to each of the first and second end portions of the connection cable of the present invention, so the magnetic attraction of the two end portions can easily complete the storage of the connection cable and effectively reduce the size of the connection cable in storage. Besides, compared with the conventional nonmagnetic connection cable, which needs to be furled for storage, the present invention can avoid excessive curvature resulting easily into damage. Moreover, the two end portions of the connection cable are magnetically attractive, so the connection cable can function as a magnetic fastener.

Although the present invention has been described with respect to a specific preferred embodiment thereof, it is in no way limited to the specifics of the illustrated structures but changes and modifications may be made within the scope of the appended claims.

What is claimed is:

1. A magnetic connection cable comprising:
a main body having a first end portion and a second end portion opposite to the first end portion; and
two magnets mounted to the first and second end portions respectively, the two magnets being not located on an imaginary long axis of the main body.

2. The magnetic connection cable as defined in claim 1, wherein the main body comprises a conducting wire and two casings mounted to a first distal end and a second distal end of the conducting wire, the first distal end of the conducting wire and one of the two casings jointly defining the first end portion, the second distal end of the conducting wire and the other casing jointly defining the second end portion.

3. The magnetic connection cable as defined in claim 2, wherein each of the two magnets is mounted to one of the two casings.

4. The magnetic connection cable as defined in claim 2, wherein each of the each of the magnets is mounted to an inner side of one of the casings.

5. The magnetic connection cable as defined in claim 1, wherein at least one of the first and second end portions is a USB port.
